(19) United States
(12) Patent Application Publication
(10) Pub. No.: US 2003/0088722 A1
(43) Pub. Date: May 8, 2003

(54) System and method for managing priorities in a PCI bus system

(76) Inventor: David Price, Cambridgeshire (GB)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 09/682,966

(22) Filed: Nov. 2, 2001

(51) Int. Cl. G06F 12/00; G06F 13/14; G06F 13/38

(52) U.S. Cl. 710/244

(57) ABSTRACT

A system and method is provided for arbitrating ownership of a PCI bus among multiple connected devices. In particular, the present system and method provides for a continual shift of device priorities depending on how that device makes use of the bus (how often and for how long). This arbiter design differs from a conventional arbiter implementation in that it is very flexible allowing the behavior to be tailored to the requirements of the system as a whole. The arbitration methodology includes setting initial maximum and minimum priority values for each connected device. When a device is granted bus ownership, its maximum priority value is decremented by one, thereby changing its priority in relation to other devices which may request bus ownership. When the devices maximum priority value falls below that of another device requesting ownership, the first device must release bus ownership to the second device. By providing programmable priorities for each device, a ranking of the devices on the bus can be established that can change as conditions require.

### FIELD OF THE INVENTION

The present invention relates generally to data processing systems and, in particular, to systems and methods for managing bus ownership in the data processing system having a PCI bus architecture.

### BACKGROUND OF THE INVENTION

Modern data processing systems such as personal computers (PC's) typically include a master microprocessor as well as a plurality of devices connected to the master microprocessor and each including an independent local intelligent processor, such as various communications devices (e.g., modems and network interface cards (NIC's)), video cards, as well as other types of expansion boards. Each of the various devices connected to the system must share information with other devices as well as access common system resources. To facilitate this data transfer, bus architecture was developed wherein data is passed between the devices. Conventionally, a bus has two primary components, a data bus and an address bus. Initially, during an address phase, addresses are sent over the address bus to signal a memory location. Subsequently, during a data phase, data is transferred over the data bus to the specified location. Conventional bus technology, such as ISA (Industry Standard Architecture) and EISA (Extended ISA) served this purpose however each of these architectures include limitations regarding the speed of data transfer, thus limiting the speed of the various input/output (I/O) operations required by the connected devices.

With the increase in processor speeds and performance, the need arose for a corresponding increase in I/O operation speed. To this end, Intel Corporation in the early 1990's developed Peripheral Component Interconnect (PCI) bus technology, which enables a higher throughput of data between the various devices, thereby enabling the speed of various I/O operations to be substantially increased. The PCI architecture has since been adopted as an industry standard by the PCI Special Interest Group (PCI SIG), with the current standard being embodied in PCI Local Bus Specifications, Revision 2.2, released by PCI SIG on Dec. 18, 1998.

The PCI architecture is a synchronous bus architecture wherein all data transfers between devices are performed relative to a system clock (CLK) typically running at a maximum speed of either 33 or 66 MHz. For reference, a PCI bus clock speed of 33 MHz equates to one bus transfer occurring every 30 nanoseconds. Further, the PCI bus architecture typically implements either a 32 or 64-bit multiplexed Address and Data bus. At 33 MHz, a 32-bit bus supports a maximum data transfer rate of 132 MBytes/sec.

Using PCI architecture, all data is transferred between an initiator device (the initiator) which is referred to as the bus master for the given transfer, and a target device (the target) which is the bus slave for the transfer. The initiator drives the signals during the address phase to signal the type of transfer to occur, such as memory read, memory write, I/O read, I/O write, etc. In operation, a typical PCI bus transfer consists of one address phase and any number of data phases. Because only one bus transfer can occur over the PCI bus during a single clock cycle, initiators must request access to the bus, commonly referred to as bus ownership, prior to delivering any data across it. Further, since multiple devices may request ownership of the bus simultaneously, decisions must be made regarding the relative priority of the given devices and their requested operations. To accommodate this decision making process, the PCI bus typically includes bus arbitration programming which sets the rules for determining which initiator is granted ownership of the bus for the next clock cycle.

Initiators arbitrate for ownership of the bus by asserting a REQ# signal to a central arbiter. Upon implementation of its arbitration scheme, the arbiter grants ownership of the bus by asserting the GNT# signal to the initiator having the highest priority. Each PCI device connected to the arbiter and capable of initiating a bus transfer has unique REQ# and GRANT# signals which distinguish it from other devices. Once granted to a device, use of the bus may begin during the following clock cycle.

As briefly mentioned above, the granting of bus ownership is typically regulated by an arbitration scheme that establishes the bus priority among the various connected devices. One conventional arbitration scheme is a fixed priority scheme wherein the connected devices are granted bus ownership in a pre-established order. That is, if one device is given a higher fixed priority than another, each time the two devices request bus ownership simultaneously, the first device would always receive ownership. Circumstances dictate that in certain situations, fixed priority schemes are not acceptable, in that low priority level devices could constantly be denied bus ownership, resulting in device time-out or other failure.

Accordingly, a rotation priority arbitration scheme was developed wherein device priority is moved from one connected device to the next in a turn-based manner. In an example having three connected devices, DEV1, DEV2, and DEV3, a rotation priority scheme might initially set the priority of DEV1 higher than that of DEV2 and the priority of DEV2 higher than DEV3. After one clock cycle, the bus priority for each device would shift such that DEV2 is higher than DEV3 and DEV3 is higher than DEV1. In this manner, each device would be serviced at even intervals, once every three clock cycles (assuming each device requested ownership simultaneously).

Another alternative to the fixed priority scheme is a fair rotation arbitration scheme. In a fair rotation scheme, one device is granted highest priority. Subsequently, this highest priority device is awarded bus ownership every other clock cycle (assuming simultaneous requests from other devices). The remaining devices are arbitrated in accordance with a conventional rotation scheme.

Although the above-described arbitration schemes can adequately manage bus ownership in a variety of circumstances, the PCI bus arbiter may still become the source of congestion on the bus if the priority scheme is not flexible or intelligent enough to cope with the changing demands of the connected devices. This becomes even more crucial in embedded PCI bus environments due the vast array of devices that can be connected directly or indirectly to the bus under control.

Therefore, there is a need in the art PCI bus control for a flexible PCI arbitration system for assigning and maintaining priorities for devices on an embedded PCI bus.

### SUMMARY OF THE INVENTION

The present invention overcomes the problems noted above, and provides additional advantages, by providing a system and method for arbitrating ownership of a PCI bus among multiple connected devices. In particular, the present system and method provides for a continual shift of device priorities depending on how that device makes use of the bus (how often and for how long). This arbiter design differs from a conventional arbiter implementation in that it is very flexible allowing the behavior to be tailored to the requirements of the system as a whole. The arbitration methodology includes setting initial maximum and minimum priority values for each connected device. When a device is granted bus ownership, its maximum priority value is decremented by one, thereby changing its priority in relation to other devices which may request bus ownership. When the devices maximum priority value falls below that of another device requesting ownership, the first device must release bus ownership to the second device. By providing programmable priorities for each device, a ranking of the devices on the bus can be established that can change as conditions require.

### BRIEF DESCRIPTION OF THE DRAWINGS

FIG. 1 is a block diagram illustrating a PCI bus system according to one embodiment of the present invention;

FIG. 2 is a flow chart describing a first embodiment of a method for arbitrating PCI device priority in the system of FIG. 1;

FIG. 3 is a flow chart describing a first embodiment of a method for resetting device maximum priority values according to the present invention;

FIG. 4 is a flow chart describing a second embodiment of a method for resetting device maximum priority values according to the present invention; and

FIG. 5 is a device priority arbitration chart depicting one example of an initial arbitration priority scheme for a PCI bus system having three connected devices.

### DETAILED DESCRIPTION OF THE PREFERRED EMBODIMENTS

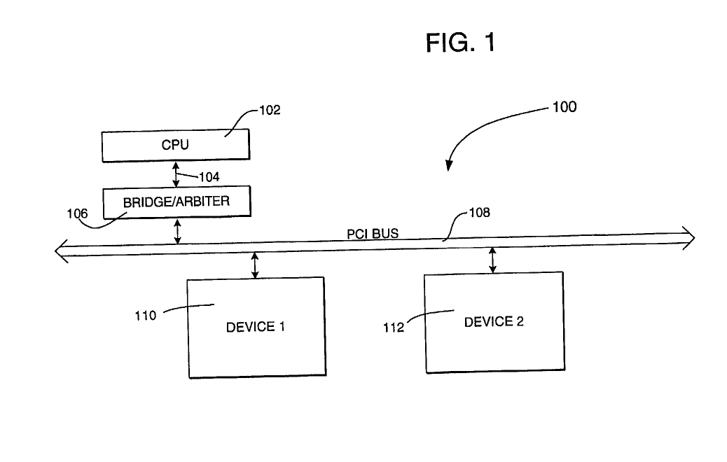

Referring generally to the figures and, in particular, to FIG. 1, there is shown a block diagram of a PCI bus system 100 according to one embodiment of the present invention. PCI bus system 100 comprises at least a CPU 102 connected by a host bus 104 to a host PCI bridge 106. Host PCI bridge 106 also operates as a PCI arbiter, although it should be understood that arbiter operations could be performed in other system components as is known in the art. A PCI bus 108 is connected to the host PCI bridge/arbiter 106 and also to a pair of PCI devices 110 and 112. With this structure, the PCI bus 108 is used for mutual connection between the devices 110 and 112 as well as any other peripheral devices provided in the PCI bus system.

In PCI bus systems, as described briefly above, the master device which carries out data transfer on the PCI bus 108 is called an initiator, and the device which receives a read request or a write request is called a target. In the example illustrated, the CPU 102 and the PCI devices 110 and 112 are operable as initiators, while the PCI devices 110 and 112 are also operable as targets. In order to manage bus ownership between the various initiator devices, the illustrated PCI bus system 100 incorporates an arbitration scheme of the present invention. Accordingly, only one device is operable as an initiator at any one time. In operation, at least one of the initiator devices asserts a REQ# signal for the PCI bus 108 to the arbiter 106. Data transfer through the PCI bus 108 can be started only when permission has been received from the arbiter in the form of a GNT# signal. In one embodiment, upon receipt of a GNT# signal, data is transferred to the host bus 104 in synchronism with a clock sequence of 66 MHz, while data transfer is carried out through the PCI bus 108 in synchronism with clock sequence of 33 MHz.

In one particular embodiment, the PCI bus is an embedded PCI bus for use as a communications channel between high speed network interfaces, such as digital subscriber line (DSL), asynchronous transfer mode (ATM), and Ethernet devices. The application of a priority arbitration scheme is more demanding than most conventional PCI bus applications in that the devices will be using the PCI bus for a great deal of traffic. Further, all of the connected devices typically have different speeds and thus different bandwidth requirements to transfer their data across the PCI bus. By providing a system and method for arbitrating bus priority among these devices as set forth in detail below, the needs for each device may be more adequately met.

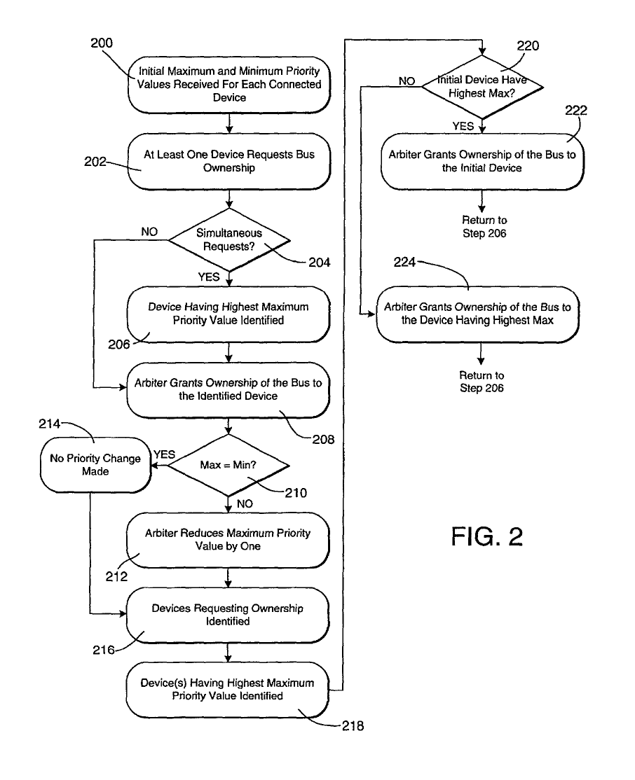

Referring now to FIG. 2, there is illustrated a flow chart describing a first embodiment of a method for arbitrating PCI device priority in the system of FIG. 1. In step 200, initial maximum and minimum priority values are received for each of the three connected PCI initiator devices (CPU 102, PCI device 110, and PCI device 112). In one embodiment, these values may be received into a priority register associated with the arbiter. In particular, each value within the priority register may be an 8 or 16 bit integer value. It should be understood that the size of the bit ranges utilized with the present invention are flexible and would necessarily depend upon the granularity required by the overall system as well as any other requirements or limitations. An 8 bit value would, however, provide a sufficient range to differentiate devices priorities. Next, in step 202, at least one of the connected PCI initiator devices requests ownership of the PCI. In response to the request, the PCI arbiter 106 determines whether or not more than one of the connected devices has simultaneously requested bus ownership in step 204. If more than one device has simultaneously requested ownership, the arbiter, in step 206, identifies the PCI initiator device having the highest maximum priority value among those devices requesting bus ownership. In step 208, the bus arbiter 106 grants ownership to the identified device. Alternatively, if in step 204, it is determined that only one device has requested bus ownership, the bus arbiter grants ownership of the PCI bus to the sole requesting device.

In step 210, once bus ownership has been granted to a device, the arbiter determines whether the maximum priority value for the device granted ownership equals its minimum priority value. If not, in step 212, the arbiter decrements the maximum priority value for the device granted bus ownership by one. However, in step 214, if the granted device's maximum priority value equals its minimum priority value, no change to priority values is made. In step 216, the arbiter 102, during the next clock cycle, identifies the devices which are now requesting bus ownership. This may or may not include the device which currently holds the bus. In step 218, of the devices requesting ownership, the one(s) having the highest priority are further identified (more than one device may have equivalent maximum priority values). In step 220, the arbiter determines whether the initial device granted bus ownership maintains the highest maximum priority value (even if other devices match this value). If so, the arbiter proceeds to step 222, where bus ownership is again granted to the initial device. However, if it is determined that another device has the highest maximum priority value among those devices requesting bus ownership, bus ownership, is granted to the other device in step 224. Similarly, if the initial device no longer requests bus access, the system necessarily proceeds to step 224, where bus ownership is granted to the device having the highest maximum priority value. At this point, the method is returned to step 206 in an iterative fashion.

Basically, each time the bus goes to idle but the request from that same device has not been de-asserted (i.e., the device still wants ownership of the bus) its maximum priority value is decremented by one. This process is continued until the bus is de-asserted by the device or the device's maximum priority value equals its minimum priority value. The decrementing of the first device's maximum priority value has no consequence in circumstances where the maximum and minimum priority ranges of the connected devices have been chosen without overlap (Min of one device with Max of other) and will again work as if each device had only a single priority value. However, if there is overlap in priority ranges then as a device holds the bus for multiple transactions, its maximum priority value falls during each successive iteration (until it reaches the preset minimum priority value) and may become lower than another device requesting ownership of the bus. At this point, the first device is forced to release ownership of the bus to the new device. The new device's maximum will similarly decrement such that its priority may fall below the original device and so relent back after only one transaction. Thus, the lower priority device obtains at least intermittent service by the bus thereby preventing such problems as the device timing out.

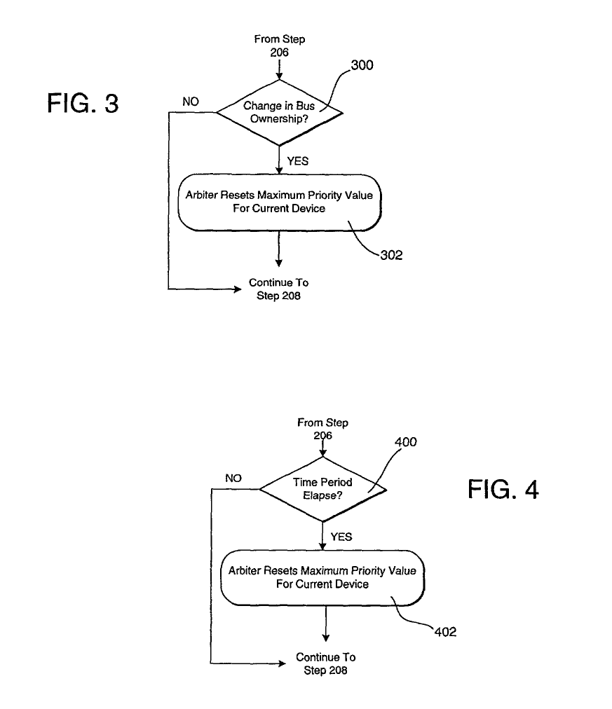

In addition to the above-described method steps, the present system also incorporates multiple embodiments of a provision for resetting the device maximum priority values back to their respective initial values. Referring now to FIG. 3, there is shown a flow chart describing a first embodiment of a method for resetting device maximum priority values according to the present invention. In one embodiment, such method for resetting the maximum priority values may be inserted prior to step 206 above. In step 300, the bus arbiter identifies whether a change in bus ownership has occurred. As set forth above, this occurs when a new device's maximum priority value exceeds the maximum priority value for the device currently having ownership of the bus.

If it is determined in step 300 that a change in bus ownership has occurred then, in step 302, the arbiter resets the maximum priority value for the device that just lost ownership of the bus to its initial maximum priority value. This ensures that the new bus owning device gets only one transaction before the original device gets back in and won't be able to get in again for a longer number of transactions (perhaps enough to transfer a packets etc, depends on the granularity of the data that is processed/transferred). The process is then returned to step 208 described above. However, if in step 300 it is determined that a change in bus ownership has not occurred, maximum priority values are not reset to their initial values and the arbiter continues to step 208.

Referring now to FIG. 4, there is shown an alternative method for resetting the maximum priority values for each device. As above, this method may be inserted prior to step 206. In step 400, the bus arbiter identifies whether a predetermined time period has elapsed since the last priority maximum value reset. In one embodiment, the predetermined time period may be one day. If it is determined in step 400 that the predetermined time period has elapsed then, in step 402, the arbiter resets the maximum priority value for each device its initial maximum priority value. The process is then returned to step 208 described above. However, if in step 400 it is determined that the predetermined time period has not elapsed, maximum priority values are not reset to their initial values and the arbiter continues to step 208.

It should be understood that the reset methodology utilized may also comprise a mixture of the two above embodiments on a per device basis. That is, certain devices may be reset upon losing bus ownership while other devices are reset based upon a predetermined time factor. In this manner, device priorities can be managed in any desirable fashion.

As an alternative to the above-described maximum priority value decrementing scheme, the arbiter may also determine, prior to decrementing the maximum priority value, whether another device has requested ownership of the bus. Further, the arbiter determines whether the device has been programmed to reset upon release or upon time period expiration. For devices set to reset upon release to another device (FIG. 3), the arbiter decrements the device's maximum priority value regardless of a simultaneous request by another device. This occurs because it is known that the maximum priority value for that device will reset upon release. Alternatively, for devices set to release upon expiration of a given time period (FIG. 4), the arbiter decrements the device's maximum priority value only when other devices are requesting bus ownership simultaneously in order to preserve the intended priority scheme for a longer duration. It should be understood that the above embodiments are merely exemplary and the system of the present invention may be programmed to enhance the flexibility of the system.

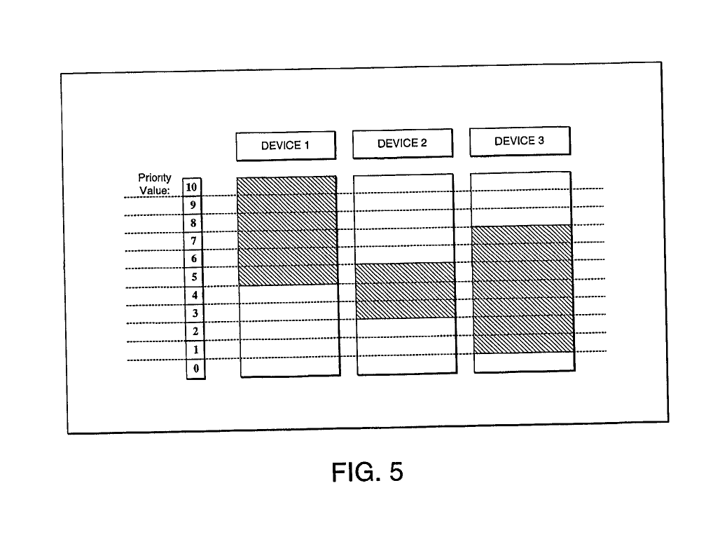

Referring now to FIG. 5, there is shown a device priority arbitration chart depicting one example of an initial arbitration priority scheme for a PCI bus system having three connected devices. For the purposes of description, it will be assumed that each connected devices concurrently requests bus ownership, thereby illustrating the manner of operation of the inventive arbitration scheme. Each device connected to the PCI bus is afforded an initial range of priority levels bounded by respective maximum and minimum values. In FIG. 5, it can be seen that Device 1 has a priority maximum of 10 and a priority minimum of 5; Device 2 has a priority maximum of 5 and a priority minimum of 3; and Device 3 has a priority maximum of 7 and a priority minimum of 1.

Applying the methodology set forth in FIG. 2, it can be seen that if all three devices request bus ownership simultaneously, then Device 1 would be initially granted bus ownership due to its higher maximum priority value. Upon completion of a clock cycle (or other similar time period), the maximum priority value of Device 1 is decremented from 10 to 9. Similarly, in second and third cycles, Device 1's maximum priority of 9 and 8, respectively, remains the highest priority level of the three requesting devices. In a fourth cycle, the maximum priority value of Device 1 equals that of Device 3. However, since Device 1 has not yet de-asserted ownership of the bus, Device maintains ownership. It is not until the fifth cycle that Device 1 releases bus ownership to Device 3.

Device 3 maintains bus ownership for the sixth cycle and then relents back to Device 1 for the seventh cycle. In the eighth cycle, all three device share a common maximum priority value of 5. However, as above, where bus ownership has not be de-asserted, the asserting device maintains ownership. Now, because Device 1 has reached its maximum=minimum level, which is at least as high as any other device, any subsequent request by Device 1 will be granted. However, if Device 1 does not assert ownership in the ninth cycle (or any subsequent cycle), device 2 is granted ownership of the bus for one cycle. In one embodiment, the decision to grant ownership to device 2 (where device 2 and device 3 have equal maximum priority values and are both non-asserting devices) is based upon a round robin selection scheme whereby there is an implied ordering of the devices e.g., device 1>device 2>device 3. Using this methodology, when non-asserting devices 2 and 3 both request ownership, device 2 will have priority over device 3. Devices 2 and 3 then alternate bus ownership until Device 2 reaches its minimum priority value of 3. At this point, any request by Device 2 (where Device 1 is not requesting) will be granted. At this point, only when Device 3 is the sole requesting device will it be granted ownership of the bus.

By following the arbitration methodology of the present invention, bus priority for all devices can be effectively managed such that their respective needs can be met while still reducing the likelihood of other devices timing out or performing retries, thereby ensuring the integrity of all the connections in the system. Further, the flexibility of the inventive priority system allows generic devices to be attached but allows the priority system for those devices to be mapped specifically to it's requirements and the requirements of the whole system that is being built. The system is designed as a moving priority system and the mechanism is implemented using a maximum and minimum priority pair that is independently specified for each individual device. Further, if a more simplistic approach is desired, the present system may be configured so that each connected device has identical maximum and minim priority values, thereby as a conventional one value priority arbiter. Otherwise, these values can be used to allow for variations in the behavior of the system.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed is:

1. A system for managing priorities in a PCI bus system, comprising:
a PCI bus;
at least two PCI devices operatively connected to the PCI bus; and
a PCI arbiter operatively connected to the PCI bus for arbitrating PCI bus ownership among the at least two PCI devices;
wherein maximum and minimum priority values are assigned to each of the at least two PCI devices;
wherein, upon receiving simultaneous ownership requests from at least two requesting PCI devices, the PCI arbiter grants ownership of the PCI bus to the one of the at least two requesting PCI devices having the higher maximum priority value; and
wherein the maximum priority value for the PCI device granted ownership of the bus is decremented.

2. The system of claim 1, wherein the PCI arbiter, following the granting of PCI bus ownership to the one of the at least two requesting PCI devices having the higher maximum priority value, determines whether the maximum priority value for the PCI device granted ownership of the PCI bus is equal to the minimum priority value for the PCI device granted ownership of the PCI bus; and
wherein the maximum priority value for the PCI device granted ownership of the PCI bus is decremented only if it is determined that the maximum priority value for the PCI device granted ownership of the PCI bus is not equal to the minimum priority value for the PCI device granted ownership of the PCI bus.

3. The system of claim 1, wherein the PCI arbiter determines whether a PCI device currently maintaining ownership of the PCI bus is one of the at least two PCI devices requesting ownership of the PCI bus; and
wherein the PCI arbiter grants ownership of the PCI bus to the PCI device currently maintaining ownership of the PCI bus if it is determined that the PCI device currently maintaining ownership has a maximum priority value at least equal to the highest maximum priority value for the at least two requesting PCI devices.

4. The system of claim 1, wherein the PCI arbiter determines whether a change in bus ownership has occurred; and
wherein the maximum priority value for the PCI device losing bus ownership is reset to its initial value if it is determined that a change in bus ownership has occurred.

5. The system of claim 1, wherein the PCI arbiter determines whether a predetermined time period has elapsed; and
wherein the maximum priority value for the PCI device losing bus ownership is reset to its initial value if it is determined that the predetermined time period has elapsed.

6. The system of claim 5, wherein the predetermined time period is twenty four hours.

7. The system of claim 1, wherein one of the at least two PCI devices includes a central processing unit.

8. The system of claim 1, wherein one of the at least two PCI devices includes a PCI network interface card.

9. The system of claim 1, wherein one of the at least two PCI devices includes a PCI video card.

10. The system of claim 1, wherein one of the at least two PCI devices includes a PCI modem.

11. A method for managing priorities in a PCI bus system, comprising the steps of:
assigning maximum and minimum priority values to each of at least two PCI devices operatively connected to a PCI bus;
receiving simultaneous ownership requests from at least two requesting PCI devices;
determining which one of the at least two requesting PCI devices has the highest maximum priority value;
granting ownership of the PCI bus to the one of the at least two requesting PCI devices having the higher maximum priority value; and
decrementing the maximum priority value for the PCI device granted ownership of the PCI bus.

12. The method of claim 11, further comprising the step of:
decrementing the maximum priority value of the PCI device granted ownership of the PCI bus only if it is determined that the maximum priority value for the PCI device granted ownership of the PCI bus is not equal to the minimum priority value for the PCI device granted ownership of the PCI bus.

13. The method of claim 11, further comprising the steps of:
determining whether a PCI device currently maintaining ownership of the PCI bus is one of the at least two PCI devices requesting ownership of the PCI bus; and
granting ownership of the PCI bus to the PCI device currently maintaining ownership of the PCI bus if it is determined that the PCI device currently maintaining ownership has a maximum priority value at least equal to the highest maximum priority value for the at least two requesting PCI devices.

14. The method of claim 11, further comprising the steps of:
determining whether a change in bus ownership has occurred; and
resetting the maximum priority value for the PCI device losing bus ownership to its initial value if it is determined that a change in bus ownership has occurred.

15. The method of claim 11, further comprising the steps of:
determining whether a predetermined time period has elapsed; and
resetting the maximum priority value for the PCI device losing bus ownership to its initial value if it is determined that the predetermined time period has elapsed.

16. The method of claim 15, wherein the predetermined time period is twenty four hours.

17. The method of claim 11, wherein one of the at least two PCI devices includes a central processing unit.

18. The method of claim 11, wherein one of the at least two PCI devices includes a PCI network interface card.

19. The method of claim 11, wherein one of the at least two PCI devices includes a PCI video card.

20. The method of claim 11, wherein one of the at least two PCI devices includes a PCI modem.
